(19) United States
(12) Patent Application Publication
(10) Pub. No.: US 2012/0111706 A1
(43) Pub. Date: May 10, 2012

(54) Push button assembly

(75) Inventors: Timothy W. Seckel, Streamwood, IL (US); Eleobardo Moreno, St. John, IN (US)

(73) Assignee: WMS Gaming Inc., Waukegan, IL (US)

(21) Appl. No.: 13/291,835

(22) Filed: Nov. 8, 2011

Related U.S. Application Data
(60) Provisional application No. 61/411,154, filed on Nov. 8, 2010.

(51) Int. Cl. H01H 13/14

(52) U.S. Cl. 200/345

(57) ABSTRACT

A push-button assembly for a gaming terminal is operative to actuate a switch or other actuator. The push-button assembly includes a plunger extending into a bezel to actuate the switch. The push-button assembly further includes a bifurcated gasket, having a positioning band that bifurcates into two diverging arms, positioned between a plunger sealing perimeter and a bezel rim so that, while the plunger moves between an extended position and a retracted position, the bifurcated gasket continuously contacts the plunger sealing perimeter and the bezel rim.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to a gaming apparatus, and methods for playing wagering games, and more particularly, to mechanical button-type switch actuators utilized as player-input devices on a gaming apparatus.

### BACKGROUND OF THE INVENTION

Gaming terminals, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options.

Gaming terminals can be located in high-traffic areas and can experience continuous use over extended periods of time. Gaming terminals also require player-input devices such as buttons on a button panel. Both the terminals as well as terminal components such as mechanical and electro-mechanical buttons are susceptible to damage and wear as a result of typical use and occasional misuse.

It would be useful to develop terminals and terminal components such as input devices to increase reliability and longevity of the terminals and input devices.

### SUMMARY OF THE INVENTION

According to one aspect of the invention, a push-button assembly operative to actuate a switch includes a bezel mounted on a button panel, the bezel comprising a bezel throat and a bezel rim surrounding the bezel throat. The push-button assembly includes a plunger extending into the bezel throat to actuate the switch. The plunger comprises a plunger cap and a stem protruding from the plunger cap, the plunger having a sealing perimeter that surrounds the stem, the stem being positioned in the bezel throat so that the sealing perimeter overhangs the bezel rim, and the stem being linearly moveable in the bezel throat between an extended position and a retracted position. The push-button assembly further includes a bifurcated gasket encircling the stem between the sealing perimeter and the bezel rim, the bifurcated gasket comprising a positioning band proximal the stem, the positioning band bifurcating outwards from the stem to form a plunger arm and a bezel arm, the plunger arm and the bezel arm being biased to diverge. The gasket is positioned between the bezel rim and the sealing perimeter so that, while the stem moves between the extended position and the retracted position, the bezel rim continuously contacts the bezel arm and the sealing perimeter continuously contacts the plunger arm.

According to another aspect of the invention, a push-button assembly operatively connected to a panel includes a bezel comprising a bezel throat, a bezel rim, and at least one panel mount securing the bezel rim to the panel. The push-button assembly also includes a plunger extending into the bezel throat to actuate a switch, the plunger comprising a plunger cap and a stem protruding from the plunger cap, the plunger having a sealing perimeter that surrounds the stem, the stem being positioned in the bezel throat so that the sealing perimeter overhangs the bezel rim, the stem being linearly moveable in the bezel throat between an extended position and a retracted position. During travel of the stem from the retracted position to the extended position, the plunger engages the bezel to stop the plunger moving away from the retracted position, and during travel of the stem from the extended position to the retracted position the plunger engages the bezel via the sealing perimeter overhanging the bezel rim to stop the plunger moving away from the extended position. The pushbutton assembly further includes a bifurcated gasket encircling the stem between the sealing perimeter and the bezel rim, the bifurcated gasket comprising a positioning band proximal the stem, the positioning band bifurcating outwards from the stem to form a plunger arm and a bezel arm, the plunger arm and the bezel arm being biased to diverge. The bifurcated gasket is positioned between the bezel rim and the sealing perimeter so that, while the stem moves between the extended position and the retracted position, the bezel rim continuously contacts the bezel arm and the sealing perimeter continuously contacts the plunger arm.

According to yet another aspect of the invention, a push-button assembly with multi-mode tactile response includes a bezel comprising a bezel throat and a bezel rim surrounding the bezel throat. The push-button assembly includes a plunger extending into the bezel throat to actuate a switch, the plunger comprising a plunger cap and a stem protruding from the cap, the plunger cap having a sealing perimeter that surrounds the stem, the stem being positioned in the bezel throat so that the sealing perimeter overhangs the bezel rim, the stem being linearly moveable in the bezel throat. The push-button assembly further includes a bifurcated gasket encircling the stem between the sealing perimeter and the bezel rim, the bifurcated gasket comprising a positioning band proximal the stem, the positioning band bifurcating outwards from the stem to form a plunger arm and a bezel arm, the plunger arm and the bezel being biased to diverge. The push-button assembly has a weak-response mode and a strong-response mode. The push-button assembly in the weak-response mode comprises the gasket being pressed between the sealing perimeter and the bezel rim with the arms at least partly diverging, and the gasket urging the sealing perimeter and the bezel rim apart via the diverging arms resisting bending. The push-button assembly in the strong-response mode comprises the gasket being compressed between the sealing perimeter and the bezel rims with the arms not diverging, and the gasket urging the sealing perimeter and the bezel rim apart via the non-diverging arms and the positioning band resisting compressing.

According to yet another aspect of the invention, a player-input device for detecting player selections at a gaming machine includes a button panel being mounted to the gaming machine, the button panel including a plurality of push-button assemblies. At least one push-button assembly from the plurality of assemblies includes a bezel being mounted to the panel, the bezel comprising a bezel throat and a bezel rim surrounding the bezel throat, a plunger extending through the bezel throat to actuate a switch, the plunger comprising, a plunger cap and a stem protruding from the plunger cap, the plunger having a sealing perimeter that surrounds the stem, the stem being positioned in the bezel throat so that the sealing perimeter overhangs the bezel rim, the stem being linearly moveable in the bezel throat between an extended position and a retracted position. The at least one push-button assembly further includes a bifurcated gasket encircling the stem between the sealing perimeter and the bezel rim, the bifurcated gasket comprising a positioning band proximal the stem, the positioning band bifurcating outwards from the stem to form a plunger arm and a bezel arm, the plunger arm and the bezel arm being biased to diverge. The gasket is positioned between the bezel rim and the sealing perimeter so that, while the stem moves between the extended position and the retracted position, the bezel rim continuously contacts the bezel arm and the sealing perimeter continuously contacts the plunger arm.

According to yet another aspect of the invention, a gaming machine for playing a wagering game includes at least one push-button assembly for detecting player selections, the at least one push-button assembly comprising a bezel mounted to a panel of the gaming machine, the bezel comprising a bezel throat and a bezel rim surrounding the bezel throat. The at least one push-button assembly further includes a plunger extending into the bezel throat to actuate a switch, the plunger comprising a plunger cap and a stem protruding from the plunger cap, the plunger having a sealing perimeter that surrounds the stem, the stem being positioned in the bezel throat so that the sealing perimeter overhangs the bezel rim, the stem being linearly moveable in the bezel throat between an extended position and a retracted position. The at least one push-button assembly having a bifurcated gasket encircling the stem between the sealing perimeter and the bezel rim, the bifurcated gasket comprising a positioning band proximal the stem, the positioning band bifurcating outwards from the stem to form a plunger arm and a bezel arm, the plunger arm and the bezel arm being biased to diverge. The gasket is positioned between the bezel rim and the sealing perimeter so that, while the stem moves between the extended position and the retracted position, the bezel rim continuously contacts the bezel arm and the sealing perimeter continuously contacts the plunger arm.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming terminal according to an embodiment of the present invention.

FIG. 2 is a schematic view of a gaming system according to an embodiment of the present invention.

FIG. 3 is an image of an exemplary basic-game screen of a wagering game displayed on a gaming terminal, according to an embodiment of the present invention.

FIG. 4 is an exploded perspective view of a push-button assembly according to an embodiment of the present invention.

FIG. 5 is a side section view of a push-button assembly in an extended position, according to an embodiment of the present invention.

FIG. 6 is a side section view of a push-button assembly in a retracted position, according to an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

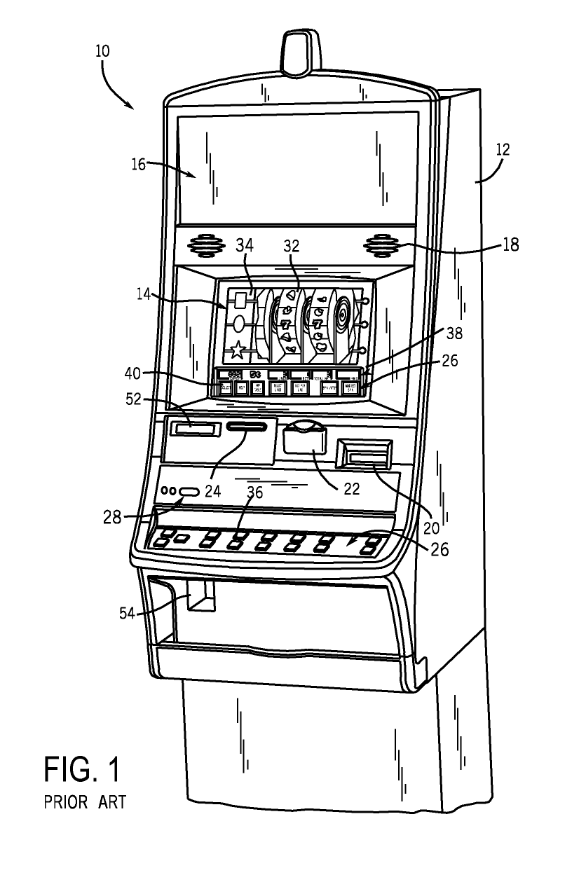

Referring to FIG. 1, there is shown a gaming terminal 10 similar to those used in gaming establishments, such as casinos. With regard to the present invention, the gaming terminal 10 may be any type of gaming terminal and may have varying structures and methods of operation. For example, in some aspects, the gaming terminal 10 is be an electromechanical gaming terminal configured to play mechanical slots, whereas in other aspects, the gaming terminal is an electronic gaming terminal configured to play a video casino game, such as slots, keno, poker, blackjack, roulette, craps, etc. It should be understood that although the gaming terminal 10 is shown as a free-standing terminal of the upright type, the gaming terminal is readily amenable to implementation in a wide variety of other forms such as a free-standing terminal of the slant-top type, a portable or handheld device primarily used for gaming, such as is disclosed by way of example in PCT Patent Application No. PCT/US2007/000792 filed Jan. 26, 2007, titled “Handheld Device for Wagering Games,” which is incorporated herein by reference in its entirety, a mobile telecommunications device such as a mobile telephone or personal digital assistant (PDA), a counter-top or bar-top gaming terminal, or other personal electronic device, such as a portable television, MP3 player, entertainment device, etcetera.

The gaming terminal 10 illustrated in FIG. 1 comprises a cabinet or housing 12. For output devices, this embodiment of the gaming terminal 10 includes a primary display area 14, a secondary display area 16, and one or more audio speakers 18. The primary display area 14 and/or secondary display area 16 variously displays information associated with wagering games, non-wagering games, community games, progressives, advertisements, services, premium entertainment, text messaging, emails, alerts or announcements, broadcast information, subscription information, etc. appropriate to the particular mode(s) of operation of the gaming terminal. For input devices, the gaming terminal 10 illustrated in FIG. 1 includes a bill validator 20, a coin acceptor 22, one or more information readers 24, one or more player-input devices 26, and one or more player-accessible ports 28 (e.g., an audio output jack for headphones, a video headset jack, a wireless transmitter/receiver, etc.). While these typical components found in the gaming terminal 10 are described below, it should be understood that numerous other peripheral devices and other elements exist and are readily utilizable in any number of combinations to create various forms of a gaming terminal in accord with the present concepts.

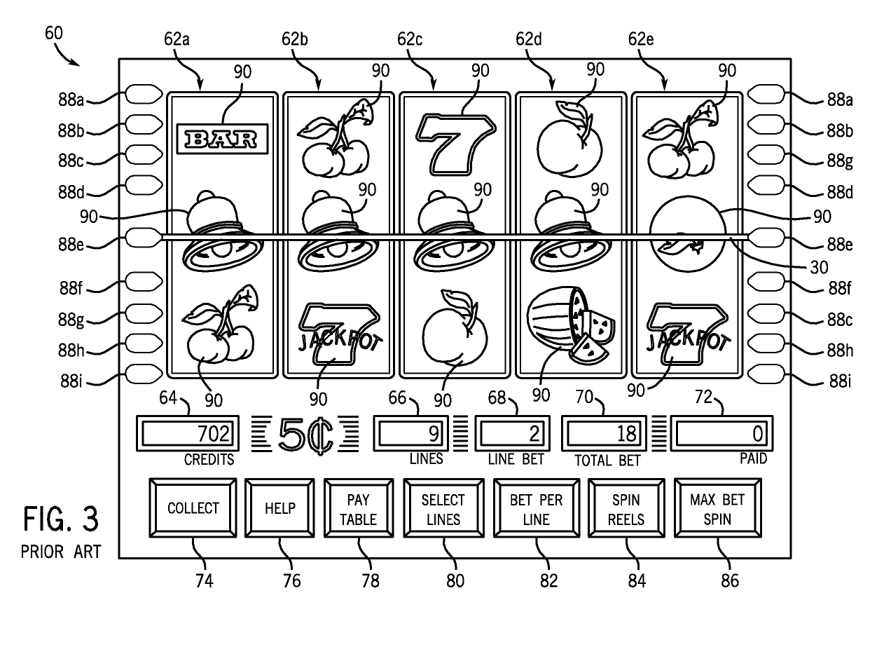

The primary display area 14 include, in various aspects of the present concepts, a mechanical-reel display, a video display, or a combination thereof in which a transmissive video display is disposed in front of the mechanical-reel display to portray a video image in superposition over the mechanical-reel display. Further information concerning the latter construction is disclosed in U.S. Pat. No. 6,517,433 to Loose et al. entitled “Reel Spinning Slot Machine With Superimposed Video Image,” which is incorporated herein by reference in its entirety. The video display is, in various embodiments, a cathode ray tube (CRT), a high-resolution liquid crystal display (LCD), a plasma display, a light emitting diode (LED), a DLP projection display, an electroluminescent (EL) panel, or any other type of display suitable for use in the gaming terminal 10, or other form factor, such as is shown by way of example in FIG. 1. The primary display area 14 includes, in relation to many aspects of wagering games conducted on the gaming terminal 10, one or more paylines 30 (see FIG. 3) extending along a portion of the primary display area. In the illustrated embodiment of FIG. 1, the primary display area 14 comprises a plurality of mechanical reels 32 and a video display 34, such as a transmissive display (or a reflected image arrangement in other embodiments), in front of the mechanical reels 32. If the wagering game conducted via the gaming terminal 10 relies upon the video display 34 only and not the mechanical reels 32, the mechanical reels 32 are optionally removed from the interior of the terminal and the video display 34 is advantageously of a non-transmissive type. Similarly, if the wagering game conducted via the gaming terminal 10 relies only upon the mechanical reels 32, but not the video display 34, the video display 34 depicted in FIG. 1 is replaced with a conventional glass panel. Further, in still other embodiments, the video display 34 is disposed to overlay another video display, rather than a mechanical-reel display, such that the primary display area 14 includes layered or superimposed video displays. In yet other embodiments, the mechanical-reel display of the above-noted embodiments is replaced with another mechanical or physical member or members such as, but not limited to, a mechanical wheel (e.g., a roulette game), dice, a pachinko board, or a diorama presenting a three-dimensional model of a game environment.

Video images in the primary display area 14 and/or the secondary display area 16 are rendered in two-dimensional (e.g., using Flash Macromedia™) or three-dimensional graphics (e.g., using Renderware™). In various aspects, the video images are played back (e.g., from a recording stored on the gaming terminal 10), streamed (e.g., from a gaming network), or received as a TV signal (e.g., either broadcast or via cable) and such images can take different forms, such as animated images, computer-generated images, or “real-life” images, either prerecorded (e.g., in the case of marketing/promotional material) or as live footage. The format of the video images can include any format including, but not limited to, an analog format, a standard digital format, or a high-definition (HD) digital format.

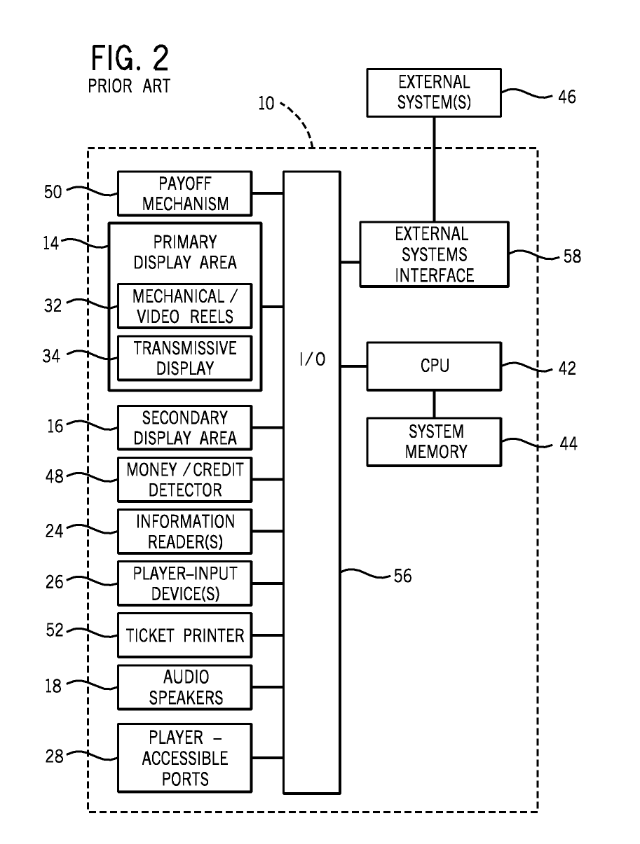

The player-input or user-input device(s) 26 include, by way of example, a plurality of buttons 36 on a button panel, as shown in FIG. 1, a mouse, a joy stick, a switch, a microphone, and/or a touch screen 38 mounted over the primary display area 14 and/or the secondary display area 16 and having one or more soft touch keys 40, as is also shown in FIG. 1. In still other aspects, the player-input devices 26 comprise technologies that do not rely upon physical contact between the player and the gaming terminal, such as speech-recognition technology, gesture-sensing technology, eye-tracking technology, etc. The player-input or user-input device(s) 26 thus accept(s) player input(s) and transforms the player input(s) to electronic data signals indicative of a player input or inputs corresponding to an enabled feature for such input(s) at a time of activation (e.g., pressing a “Max Bet” button or soft key to indicate a player's desire to place a maximum wager to play the wagering game). The input(s), once transformed into electronic data signals, are output to a CPU or controller 42 (see FIG. 2) for processing. The electronic data signals are selected from a group consisting essentially of an electrical current, an electrical voltage, an electrical charge, an optical signal, an optical element, a magnetic signal, and a magnetic element.

The information reader 24 (or information reader/writer) is preferably located on the front of the housing 12 and comprises, in at least some forms, a ticket reader, card reader, bar code scanner, wireless transceiver (e.g., RFID, Bluetooth, etc.), biometric reader, or computer-readable-storage-medium interface. As noted, the information reader may comprise a physical and/or electronic writing element to permit writing to a ticket, a card, or computer-readable-storage-medium. The information reader 24 permits information to be transmitted from a portable medium (e.g., ticket, voucher, coupon, casino card, smart card, debit card, credit card, etc.) to the information reader 24 to enable the gaming terminal 10 or associated external system to access an account associated with cashless gaming, to facilitate player tracking or game customization, to retrieve a saved-game state, to store a current-game state, to cause data transfer, and/or to facilitate access to casino services, such as is more fully disclosed, by way of example, in U.S. Patent Publication No. 2003/0045354 entitled “Portable Data Unit for Communicating With Gaming Machine Over Wireless Link,” which is incorporated herein by reference in its entirety. The noted account associated with cashless gaming is, in some aspects of the present concepts, stored at an external system 46 (see FIG. 2) as more fully disclosed in U.S. Pat. No. 6,280,328 to Holch et al. entitled “Cashless Computerized Video Game System and Method,” which is incorporated herein by reference in its entirety, or is alternatively stored directly on the portable storage medium. Various security protocols or features can be used to enhance security of the portable storage medium. For example, in some aspects, the individual carrying the portable storage medium is required to enter a secondary independent authenticator (e.g., password, PIN number, biometric, etc.) to access the account stored on the portable storage medium.

Turning now to FIG. 2, the various components of the gaming terminal 10 are controlled by one or more processors (e.g., CPU, distributed processors, etc.) 42, also referred to herein generally as a controller (e.g., microcontroller, microprocessor, etc.). The controller 42 can include any suitable processor(s), such as an Intel® Pentium processor, Intel® Core 2 Duo processor, AMD Opteron™ processor, or UltraSPARC® processor. By way of example, the controller 42 includes a plurality of microprocessors including a master processor, a slave processor, and a secondary or parallel processor. Controller 42, as used herein, comprises any combination of hardware, software, and/or firmware disposed in and/or disposed outside of the gaming terminal 10 that is configured to communicate with and/or control the transfer of data between the gaming terminal 10 and a bus, another computer, processor, or device and/or a service and/or a network. The controller 42 comprises one or more controllers or processors and such one or more controllers or processors need not be disposed proximal to one another and may be located in different devices and/or in different locations. For example, a first processor is disposed proximate a user interface device (e.g., a push button panel, a touch screen display, etc.) and a second processor is disposed remotely from the first processor, the first and second processors being electrically connected through a network. As another example, the first processor is disposed in a first enclosure (e.g., a gaming machine) and a second processor is disposed in a second enclosure (e.g., a server) separate from the first enclosure, the first and second processors being communicatively connected through a network. The controller 42 is operable to execute all of the various gaming methods and other processes disclosed herein.

To provide gaming functions, the controller 42 executes one or more game programs comprising machine-executable instructions stored in local and/or remote computer-readable data storage media (e.g., memory 44 or other suitable storage device). The term computer-readable data storage media, or “computer-readable medium,” as used herein refers to any media/medium that participates in providing instructions to controller 42 for execution. The computer-readable medium comprises, in at least some exemplary forms, non-volatile media (e.g., optical disks, magnetic disks, etc.), volatile media (e.g., dynamic memory, RAM), and transmission media (e.g., coaxial cables, copper wire, fiber optics, radio frequency (RF) data communication, infrared (IR) data communication, etc). Common forms of computer-readable media include, for example, a hard disk, magnetic tape (or other magnetic medium), a 2-D or 3-D optical disc (e.g., a CD-ROM, DVD, etc.), RAM, PROM, EPROM, FLASH-EPROM, any other memory chip or solid state digital data storage device, a carrier wave, or any other medium from which a computer can read. By way of example, a plurality of storage media or devices are provided, a first storage device being disposed proximate the user interface device and a second storage device being disposed remotely from the first storage device, wherein a network is connected intermediate the first one and second one of the storage devices.

Various forms of computer-readable media may be involved in carrying one or more sequences of one or more instructions to controller 42 for execution. By way of example, the instructions may initially be borne on a data storage device of a remote device (e.g., a remote computer, server, or system). The remote device can load the instructions into its dynamic memory and send the instructions over a telephone line or other communication path using a modem or other communication device appropriate to the communication path. A modem or other communication device local to the gaming machine 10 or to an external system 46 associated with the gaming machine can receive the data on the telephone line or conveyed through the communication path (e.g., via external systems interface 58) and output the data to a bus, which transmits the data to the system memory 44 associated with the processor 42, from which system memory the processor retrieves and executes the instructions.

Thus, the controller 42 is able to send and receive data, via carrier signals, through the network(s), network link, and communication interface. The data includes, in various examples, instructions, commands, program code, player data, and game data. As to the game data, in at least some aspects of the present concepts, the controller 42 uses a local random number generator (RNG) to randomly generate a wagering game outcome from a plurality of possible outcomes. Alternatively, the outcome is centrally determined using either an RNG or pooling scheme at a remote controller included, for example, within the external system 46.

As shown in the example of FIG. 2, the controller 42 is coupled to the system memory 44. The system memory 44 is shown to comprise a volatile memory (e.g., a random-access memory (RAM)) and a non-volatile memory (e.g., an EEPROM), but optionally includes multiple RAM and multiple program memories.

As shown in the example of FIG. 2, the controller 42 is also coupled to a money/credit detector 48. The money/credit detector 48 is configured to output a signal the controller 42 that money and/or credits have been input via one or more value-input devices, such as the bill validator 20, coin acceptor 22, or via other sources, such as a cashless gaming account, etc. The value-input device(s) is integrated with the housing 12 of the gaming terminal 10 and is connected to the remainder of the components of the gaming terminal 10, as appropriate, via a wired connection, such as I/O 56, or wireless connection. The money/credit detector 48 detects the input of valid funds into the gaming terminal 10 (e.g., via currency, electronic funds, ticket, card, etc.) via the value-input device(s) and outputs a signal to the controller 42 carrying data regarding the input value of the valid funds. The controller 42 extracts the data from these signals from the money/credit detector 48, analyzes the associated data, and transforms the data corresponding to the input value into an equivalent credit balance that is available to the player for subsequent wagers on the gaming terminal 10, such transforming of the data being effected by software, hardware, and/or firmware configured to associate the input value to an equivalent credit value. Where the input value is already in a credit value form, such as in a cashless gaming account having stored therein a credit value, the wager is simply deducted from the available credit balance.

As seen in FIG. 2, the controller 42 is also connected to, and controls, the primary display area 14, the player-input device(s) 26, and a payoff mechanism 50. The payoff mechanism 50 is operable in response to instructions from the controller 42 to award a payoff to the player in response to certain winning outcomes that occur in the base game, the bonus game(s), or via an external game or event. The payoff is provided in the form of money, credits, redeemable points, advancement within a game, access to special features within a game, services, another exchangeable media, or any combination thereof. Although payoffs may be paid out in coins and/or currency bills, payoffs are alternatively associated with a coded ticket (from a ticket printer 52), a portable storage medium or device (e.g., a card magnetic strip), or are transferred to or transmitted to a designated player account. The payoff amounts distributed by the payoff mechanism 50 are determined by one or more pay tables stored in the system memory 44.

Communications between the controller 42 and both the peripheral components of the gaming terminal 10 and the external system 46 occur through input/output (I/O) circuit 56, which can include any suitable bus technologies, such as an AGTL+ frontside bus and a PCI backside bus. Although the I/O circuit 56 is shown as a single block, it should be appreciated that the I/O circuit 56 alternatively includes a number of different types of I/O circuits. Furthermore, in some embodiments, the components of the gaming terminal 10 can be interconnected according to any suitable interconnection architecture (e.g., directly connected, hypercube, etc.).

The I/O circuit 56 is connected to an external system interface or communication device 58, which is connected to the external system 46. The controller 42 communicates with the external system 46 via the external system interface 58 and a communication path (e.g., serial, parallel, IR, RC, 10bT, near field, etc.). The external system 46 includes, in various aspects, a gaming network, other gaming terminals, a gaming server, a remote controller, communications hardware, or a variety of other interfaced systems or components, in any combination. In yet other aspects, the external system 46 may comprise a player's portable electronic device (e.g., cellular phone, electronic wallet, etc.) and the external system interface 58 is configured to facilitate wireless communication and data transfer between the portable electronic device and the controller 42, such as by a near field communication path operating via magnetic field induction or a frequency-hopping spread spectrum RF signals (e.g., Bluetooth, etc.).

The gaming terminal 10 optionally communicates with external system 46 (in a wired or wireless manner) such that each terminal operates as a “thin client” having relatively less functionality, a “thick client” having relatively more functionality, or with any range of functionality therebetween (e.g., an “intermediate client”). In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external systems 46 (“thin client” gaming terminal), or are distributed therebetween in any suitable manner (“intermediate client” gaming terminal).

Referring now to FIG. 3, an image of a basic-game screen 60 adapted to be displayed on the primary display area 14 is illustrated, according to one embodiment of the present invention. A player begins play of a basic wagering game by providing a wager. A player can operate or interact with the wagering game using the one or more player-input devices 26. The controller 42, the external system 46, or both, in alternative embodiments, operate(s) to execute a wagering game program causing the primary display area 14 to display the wagering game that includes a plurality of visual elements.

In accord with various methods of conducting a wagering game on a gaming system in accord with the present concepts, the wagering game includes a game sequence in which a player makes a wager, such as through the money/credit detector 48, touch screen 38 soft key, button panel, or the like, and a wagering game outcome is associated with the wager. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 14) through the display of information such as, but not limited to, text, graphics, text and graphics, static images, moving images, etc., or any combination thereof. In accord with the method of conducting the wagering game, the controller 42, which comprises one or more processors, transforms a physical player input, such as a player's pressing of a “Spin Reels” soft key 84 (see FIG. 3), into an electronic data signal indicative of an instruction relating to the wagering game (e.g., an electronic data signal bearing data on a wager amount).

In the aforementioned method, for each data signal, the controller 42 is configured to processes the electronic data signal, to interpret the data signal (e.g., data signals corresponding to a wager input), and to cause further actions associated with the interpretation of the signal in accord with computer instructions relating to such further actions executed by the controller. As one example, the controller 42 causes the recording of a digital representation of the wager in one or more storage devices (e.g., system memory 44 or a memory associated with an external system 46), the controller, in accord with associated computer instructions, causing the changing of a state of the data storage device from a first state to a second state. This change in state is, for example, effected by changing a magnetization pattern on a magnetically coated surface of a magnetic storage device or changing a magnetic state of a ferromagnetic surface of a magneto-optical disc storage device, a change in state of transistors or capacitors in a volatile or a non-volatile semiconductor memory (e.g., DRAM), etc.). The noted second state of the data storage device comprises storage in the storage device of data representing the electronic data signal from the controller (e.g., the wager in the present example). As another example, the controller 42 further, in accord with the execution of the instructions relating to the wagering game, causes the primary display 14 or other display device and/or other output device (e.g., speakers, lights, communication device, etc.), to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by the RNG) that is used by the controller 42 to determine the outcome of the game sequence, using a game logic for determining the outcome based on the randomly generated number. In at least some aspects, the controller 42 is configured to determine an outcome of the game sequence at least partially in response to the random parameter.

The basic-game screen 60 is displayed on the primary display area 14 or a portion thereof. In FIG. 3, the basic-game screen 60 portrays a plurality of simulated movable reels 62a-e. Alternatively or additionally, the basic-game screen 60 portrays a plurality of mechanical reels or other video or mechanical presentation consistent with the game format and theme. The basic-game screen 60 also advantageously displays one or more game-session meters and various buttons adapted to be actuated by a player.

In the illustrated embodiment of FIG. 3, the game-session meters include a “credit” meter 64 for displaying a number of credits available for play on the terminal; a “lines” meter 66 for displaying a number of paylines to be played by a player on the terminal; a “line bet” meter 68 for displaying a number of credits wagered (e.g., from 1 to 5 or more credits) for each of the number of paylines played; a “total bet” meter 70 for displaying a total number of credits wagered for the particular round of wagering; and a “paid” meter 72 for displaying an amount to be awarded based on the results of the particular round's wager. The depicted user-selectable buttons include a “collect” button 74 to collect the credits remaining in the credits meter 64; a “help” button 76 for viewing instructions on how to play the wagering game; a “pay table” button 78 for viewing a pay table associated with the basic wagering game; a “select lines” button 80 for changing the number of paylines (displayed in the lines meter 66) a player wishes to play; a “bet per line” button 82 for changing the amount of the wager which is displayed in the line-bet meter 68; a “spin reels” button 84 for moving the reels 62a-e; and a “max bet spin” button 86 for wagering a maximum number of credits and moving the reels 62a-e of the basic wagering game. While the gaming terminal 10 allows for these types of player inputs, the present invention does not require them and can be used on gaming terminals having more, less, or different player inputs.

As shown in the example of FIG. 3, paylines 30 extend from one of the payline indicators 88a-i on the left side of the basic-game screen 60 to a corresponding one of the payline indicators 88a-i on the right side of the screen 60. A plurality of symbols 90 is displayed on the plurality of reels 62a-e to indicate possible outcomes of the basic wagering game. A winning combination occurs when the displayed symbols 90 correspond to one of the winning symbol combinations listed in a pay table stored in the memory 44 of the terminal 10 or in the external system 46. The symbols 90 may include any appropriate graphical representation or animation, and may further include a “blank” symbol.

Symbol combinations are evaluated in accord with various schemes such as, but not limited to, “line pays” or “scatter pays.” Line pays are evaluated left to right, right to left, top to bottom, bottom to top, or any combination thereof by evaluating the number, type, or order of symbols 90 appearing along an activated payline 30. Scatter pays are evaluated without regard to position or paylines and only require that such combination appears anywhere on the reels 62a-e. While an embodiment with nine paylines is shown, a wagering game with no paylines, a single payline, or any plurality of paylines will also work with the present invention. Additionally, though an embodiment with five reels is shown in FIG. 3, different embodiments of the gaming terminal 10 comprise a greater or lesser number of reels in accordance with the present invention.

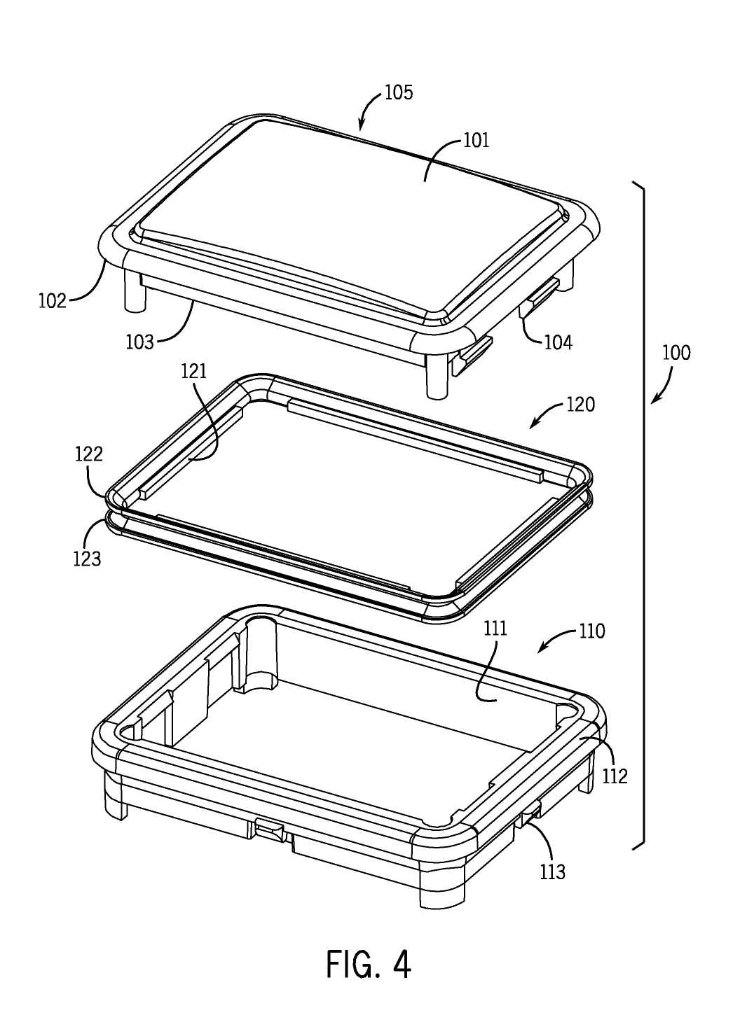

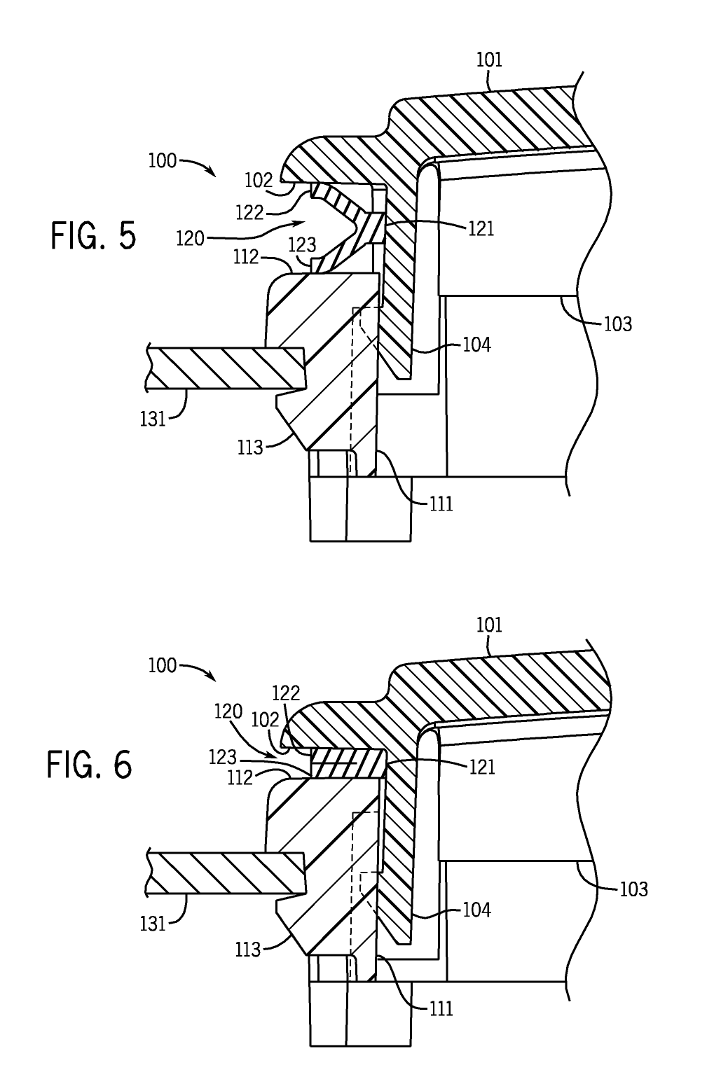

Referring to FIG. 4, a push-button assembly 100 suitable for use as a player-input device 26 is shown. The push-button assembly can be implemented as a user-selectable button and various other buttons 36 on a button panel 26 for registering player inputs. The push-button assembly 100 can be mounted to a panel 131 (FIGS. 5-6) and can actuate a switch or other device through a panel cut-out. For example, the push-button assembly 100 can be a “Spin Reels” button that the player presses to initiate a game.

The push-button assembly 100 transmits linear motion imparted to the push-button assembly 100 to a switch or other internal component positioned beneath the push-button assembly 100. Additionally, the push-button assembly 100 can protect the switch or other internal component from excessive force, impact, and over-travel damage, by limiting travel transmitted to the switch. Further, the push-button assembly can protect the switch or other component from liquid and dirt contamination arising from spillage, particulate accumulation, and cleaning procedures.

The push-button assembly 100 includes a plunger 105 comprising a plunger cap 101 with a stem 103 extending from an underside of the plunger cap 101. The stem 103 is positioned on the plunger cap 101 so that the stem 103 is surrounded by a sealing perimeter 102 formed by the underside of the plunger cap 101. The stem can be solid or hollow and may include a skirt extending from the cap 101.

The push-button assembly 100 is shown with a rectangular-shaped plunger cap 101. Alternatively, the plunger cap can be curvilinear, polygonal, irregular, and combinations of geometric and organic shapes. The plunger cap 101 can be transparent, translucent, opaque, and combinations thereof. The plunger cap 101 can be a lens, such as a lens revealing a light source.

The push-button assembly 100 further includes a bezel 110 comprising a bezel throat 111 surrounded by a bezel rim 112. The bezel 110 can be mounted to the panel 131 and can be within a cut-out thereof. The bezel rim 112 contacts the panel 131 around the perimeter of the panel cut-out and the bezel throat 111 extends through the panel cut-out from the bezel rim 112. The plunger stem 103 can extend through the bezel throat 111 to actuate a switch positioned distal the plunger cap 101, for example, a switch positioned on a circuit board beneath the panel 131 and within the gaming terminal 10.

In an embodiment of the push-button assembly 100, the bezel rim 112 can be secured to the panel 131 so that the bezel rim 112 conforms to the panel 131 and limits moisture from passing between the bezel rim 112 and the panel 131. The bezel 110 can comprise at least one panel mount for securing the bezel rim 112 to the panel 131. In some embodiments, the panel mount can be a bezel detent 113 that clamps the bezel 110 to the panel.

In the illustrated embodiment, the bezel rim 112 is elastomeric and the elastomer provides flexibility to facilitate the bezel rim 112 conforming to panel 131. The elastomeric bezel rim can have a Shore D durometer hardness measuring in the range of 50 to 90, and may be optimal in the range of 65 to 80. The selected hardness range can affect bezel rim fit to the panel, shock absorbing properties, moisture resistance, and other bezel rim characteristics.

Additional advantages can be realized with the elastomeric bezel rim. For example, the push-button assembly 100 utilizing the elastomeric bezel rim provides increased resistance to damage from repeated impact by a player and from electrostatic discharge.

In the embodiment shown in FIGS. 5 and 6, the plunger cap 101 is positioned with the stem 103 within the bezel throat 111. With the stem 103 in the bezel throat 111, the sealing perimeter 102 overhangs the bezel rim 112. The stem 103 moves linearly along the bezel throat 111 between an extended position (FIG. 5) with the plunger cap 101 positioned distal to the bezel rim 112, and a retracted position (FIG. 6) with the plunger cap 101 positioned proximal to the bezel rim 112. The stem 103 can be normally in the extended position until the player moves it to the retracted position to actuate the switch (e.g., to spin the reels.) Other embodiments can have the stem 103 normally in the retracted position and, alternatively, toggle between extended and retracted. Also, in some embodiments, the extended and retracted positions can vary from the positions shown in FIGS. 5 and 6.

The push-button assembly 100 further includes a bifurcated gasket 120 separating the plunger cap 101 and the bezel rim 112. The bifurcated gasket 120 encircles the stem 103 between the overhanging sealing perimeter 102 and the bezel rim 112. The push-button assembly 100 is configured so that the gasket 120 is pressed between the sealing perimeter 102 and the bezel rim 112 while the stem 103 moves between the extended position and the retracted position.

The bifurcated gasket 120 comprises an inner positioning band 121 proximal the stem 103. The positioning band 121 extends outwards from the stem 103 and bifurcates into a plunger arm 122 and a bezel arm 123. The plunger arm 122 and the bezel arm 123 are configured to diverge away from each other and to maintain contact with the sealing perimeter 102 and the bezel rim 112, respectively. The arms 122,123 can be deflected towards each other by contact with the sealing perimeter 102 and with the bezel rim 112, and when so deflected the arms 122, 123 are biased to diverge away from each other. The plunger arm 122 and the bezel arm 123 continuously contact the sealing perimeter 102 and the bezel rim 112, respectively, while the stem 103 moves between the extended position and the retracted position. The positioning band 121 being proximal the stem 103, and medial the stem 103 and the arms 122, 123, helps to keep the arms 122, 123 in contact with the sealing perimeter 102 and the bezel rim 112. In the embodiment shown in FIGS. 4-6, the flat profile of the positioning band 121 inhibits gasket rotation that could result in the arms 122, 123 moving away from the sealing perimeter 102 and the bezel rim 112. With each cycle of the push-button assembly 100 between the extended position and the retracted position, the gap between the sealing perimeter 102 and the bezel rim 112 closes to align the gasket 120 so that the positioning band 121 is proximal the stem 103 and so that the arms 122, 123 extend outwards from the positioning band 121. The gasket 120 limits moisture from passing between the bezel rim 112 and the sealing perimeter 102 because the bezel arm 123 continuously contacts the bezel rim 112 and the plunger arm 122 continuously contacts the sealing perimeter 102. The gasket 120 provides a moisture-resistant seal between the plunger 105 and the bezel 110 to prevent spilled drinks and other sources of moisture from contaminating and damaging switches and other electronics inside the gaming terminal.

The push-button assembly 100 described herein provides several advantages including, but not limited to, the following: it is attractive and simple; the position of the gasket 120, tucked under the plunger cap 101, protects the critical sealing surfaces from damage and displacement; the gasket configuration, with the bifurcated arms 122, 123 contacting opposing faces, minimizes relative motion between the gasket 120 and moving surfaces, reducing wear and improving sealing characteristics. Also, the push-button assembly 100 is modular and can be utilized with a variety of switches and actuators.

The plunger arm 122 and the bezel arm 123 can extend symmetrically from the positioning band 121, as illustrated. Alternatively, the plunger arm can be configured differently from the bezel arm. In some embodiments, the plunger arm can comprise distinctive features for engaging the sealing perimeter, and the bezel arm can comprise distinctive features for engaging the bezel rim. Similarly, the sealing perimeter and the bezel rim can comprise distinctive features for engaging the plunger arm and the bezel arm, respectively.

The gasket 120 can be an elastomeric gasket, where the elastomer provides flexibility to facilitate the gasket 120 conforming to the sealing perimeter 102 and to the bezel rim 112. The elastomeric gasket 120 can have a Shore A durometer hardness measuring in the range of 5 to 50, and may be optimal in the range of 10 to 20. Gasket hardness can affect arm flexibility, wear resistance, restoring force imparted to the plunger, and various other gasket characteristics. Alternatively, the gasket 120 can comprise various materials and combinations of materials that enable the arms 122, 123 to maintain contact with the sealing perimeter 102 and the bezel rim 112 while the stem 103 moves up and down.

In some embodiments, the plunger cap 101 can comprise a non-opaque lens. The lens can pass light emitted from a light source underneath the cap 101. For example, some switches can include lighting to indicate switch position. The lens can be utilized with lighted switches to provide visual cues as to switch position. In one embodiment, the push-button assembly actuates a switch that operates an OLED display that can display static and varying images through the lens in response to controller signals.

Another embodiment of the push-button assembly actuates an optical switch comprising a photoemitter that projects a light beam onto a photodetector. The photodetector maintains the switch open or closed depending on receiving light from the photoemitter. Operating the push-button assembly can move a barrier that blocks the light beam from the photoemitter to the photodetector in order to cycle the switch.

In some embodiments, the plunger 105 and the bezel 110 can engage to limit plunger travel within the bezel throat 111. For example, the stem 103 in the extended position can engage the bezel 110 in order to stop the plunger from exiting the bezel throat while moving away from the retracted position. The stem 103 can engage the bezel 110 via a stem detent 104, and via various engagement means and combinations thereof. Similarly, the plunger in the retracted position can engage the bezel 110 in order to limit plunger travel towards the bezel 110. Alternatively, the plunger 105 can engage the bezel 110 via various engagement means, including via the sealing perimeter 102 overhanging the bezel rim 112 and compressing the gasket 120 between the sealing perimeter 102 and the bezel rim 112. In the latter case, the gasket 120 can provide shock absorption by distributing force between the bezel 110 and the plunger 105 through the gasket 120 and across the sealing perimeter 102 and the bezel rim 112.

The push-button assembly 100 including the bifurcated gasket 120 can provide multi-mode tactile response to the player activating the button. The bifurcated gasket 120 exerts force on the plunger 105, urging the plunger 105 away from the bezel 110, and this force is transmitted to the player. The push-button assembly 100 has a weak-response mode affecting a portion of plunger travel from the extended position towards the bezel 110. The gasket 120, in weak-response mode, has bifurcated arms 122, 123 deflected towards each other while still diverging. As such, the force transmitted to the player results from the arms 122, 123 urging the plunger 105 and bezel 110 apart due to the diverging arms 122, 123 resisting bending. In the weak-response mode, the push-button assembly 100 provides smooth travel and a light restoring force that has been found to be tactilely satisfying to the player.

Alternatively, as shown in FIG. 6, the push-button assembly 100 has a strong-response mode affecting a portion of plunger travel from the retracted position away from the bezel 110. With the gasket 120 in strong-response mode, which is analogous to a compression spring at solid height, the arms 122, 123 are not diverging but are extended side by side and compressed along their length, although the arms 122, 123 are still biased to diverge. In strong-response mode the gasket arms 122, 123 and the positioning band 121 are pressed between the sealing perimeter 102 and the bezel rim 112, and the gasket material is in compression across its thickness. The non-diverging arms 122, 123 and the positioning band 121 urge the plunger 105 and the bezel 110 apart via the gasket material resisting compressing. Force transmitted from the plunger cap 101 to the bezel 110 is distributed and diffused by the gasket 120 across the sealing perimeter 102 and the bezel rim 112, providing the push-button assembly 100 superior shock-absorbing characteristics in the event of over-travel and excessive impact. In the strong-response mode, the push-button assembly 100 provides a stronger restoring force than in the weak-response mode, and imparts the stronger force to the player to indicate the end of plunger travel.

Each of these embodiments and obvious variations thereof is contemplated as falling within the spirit and scope of the claimed invention, which is set forth in the following claims.

1. A push-button assembly operative to actuate a switch, the push-button assembly comprising:
a bezel being mounted on a button panel, the bezel comprising a bezel throat and a bezel rim surrounding the bezel throat;
a plunger extending into the bezel throat to actuate the switch, the plunger comprising:
a plunger cap and a stem protruding from the plunger cap, the plunger having a sealing perimeter that surrounds the stem, the stem being positioned in the bezel throat so that the sealing perimeter overhangs the bezel rim, the stem being linearly moveable in the bezel throat between an extended position and a retracted position; and
a bifurcated gasket encircling the stem between the sealing perimeter and the bezel rim, the bifurcated gasket comprising:
a positioning band proximal the stem, the positioning band bifurcating outwards from the stem to form a plunger arm and a bezel arm, the plunger arm and the bezel arm being biased to diverge; and
wherein the gasket is positioned between the bezel rim and the sealing perimeter so that, while the stem moves between the extended position and the retracted position, the bezel arm continuously contacts the bezel rim and the plunger arm continuously contacts the sealing perimeter.

2. The push-button assembly of claim 1, wherein the stem is hollow.

3. The push-button assembly of claim 1, wherein the bifurcated gasket is an elastomeric gasket.

4. The push-button assembly of claim 3, wherein the bifurcated gasket comprises liquid silicone rubber.

5. The push-button assembly of claim 3, wherein the bifurcated gasket has a Shore A durometer hardness in the range of 5 to 50.

6. The push-button assembly of claim 1, wherein the bezel rim is an elastomeric bezel rim.

7. The push-button assembly of claim 6, wherein the bezel rim comprises polyurethane.

8. The push-button assembly of claim 6, wherein the bezel rim has a Shore D durometer hardness in the range of 50 to 90.

9. The push-button assembly of claim 1, wherein the bezel rim is secured to the panel so that the bezel rim conforms to the panel and limits moisture from passing between the bezel rim and the panel.

11. The push-button assembly of claim 1, wherein the plunger cap further comprises a lens.

12. The push-button assembly of claim 1 wherein, when the plunger is in the retracted position, the gasket is compressed between the sealing perimeter and the bezel rim so that the arms are not diverging and so that the compressed gasket including the positioning band distributes force across the sealing perimeter and across the bezel rim.

13. The push-button assembly of claim 1, wherein, during travel of the stem from the retracted position to the extended position, the plunger engages the bezel to stop the plunger moving away from the retracted position.

14. The push-button assembly of claim 12, wherein the plunger engages the bezel via a detent.

15-18. (canceled)

19. The push-button assembly of claim 1, wherein the bezel rim is an elastomeric bezel rim, and a panel mount secures the bezel rim to the panel so that the bezel rim conforms to the panel and limits moisture from passing between the bezel rim and the panel.

20. (canceled)

21. A push-button assembly with multi-mode tactile response, the push-button assembly comprising:
a bezel comprising a bezel throat and a bezel rim surrounding the bezel throat;
a plunger extending into the bezel throat to actuate a switch, the plunger comprising:
a plunger cap and a stem protruding from the cap, the plunger cap having a sealing perimeter that surrounds the stem, the stem being positioned in the bezel throat so that the sealing perimeter overhangs the bezel rim, the stem being linearly moveable in the bezel throat; and
a bifurcated gasket encircling the stem between the sealing perimeter and the bezel rim, the bifurcated gasket comprising:
a positioning band proximal the stem, the positioning band bifurcating outwards from the stem to form a plunger arm and a bezel arm, the plunger arm and the bezel being biased to diverge;
wherein the push-button assembly has a weak-response mode and a strong-response mode;
in the weak-response mode, the gasket being pressed between the sealing perimeter and the bezel rim with the arms at least partly diverging, and the gasket urging the sealing perimeter and the bezel rim apart via the diverging arms resisting bending; and
in the strong-response mode, the gasket being compressed between the sealing perimeter and the bezel rims with the arms not diverging, and the gasket urging the sealing perimeter and the bezel rim apart via the non-diverging arms and the positioning band resisting compressing.

22. The push-button assembly of claim 20, wherein, in the weak-response mode, the gasket urges the sealing perimeter and the bezel rim apart with less force than in the strong-response mode.

23. A player-input device for detecting player selections at a gaming machine, the player-input device comprising:
a button panel being mounted to the gaming machine, the button panel including a plurality of push-button assemblies, at least one push-button assembly from the plurality of assemblies comprising:
a bezel being mounted to the panel, the bezel comprising a bezel throat and a bezel rim surrounding the bezel throat;
a plunger extending through the bezel throat to actuate a switch, the plunger comprising:
a plunger cap and a stem protruding from the plunger cap, the plunger having a sealing perimeter that surrounds the stem, the stem being positioned in the bezel throat so that the sealing perimeter overhangs the bezel rim, the stem being linearly moveable in the bezel throat between an extended position and a retracted position; and
a bifurcated gasket encircling the stem between the sealing perimeter and the bezel rim, the bifurcated gasket comprising:
a positioning band proximal the stem, the positioning band bifurcating outwards from the stem to form a plunger arm and a bezel arm, the plunger arm and the bezel arm being biased to diverge;
wherein the gasket is positioned between the bezel rim and the sealing perimeter so that, while the stem moves between the extended position and the retracted position, the bezel rim continuously contacts the bezel arm and the sealing perimeter continuously contacts the plunger arm.

24. A gaming machine for playing a wagering game, the gaming machine including at least one push-button assembly for detecting player selections, the at least one push-button assembly comprising:
a bezel being mounted to a panel of the gaming machine, the bezel comprising a bezel throat and a bezel rim surrounding the bezel throat;
a plunger extending into the bezel throat to actuate a switch, the plunger comprising,
a plunger cap and a stem protruding from the plunger cap, the plunger having a sealing perimeter that surrounds the stem, the stem being positioned in the bezel throat so that the sealing perimeter overhangs the bezel rim, the stem being linearly moveable in the bezel throat between an extended position and a retracted position; and
a bifurcated gasket encircling the stem between the sealing perimeter and the bezel rim, the bifurcated gasket comprising:
a positioning band proximal the stem, the positioning band bifurcating outwards from the stem to form a plunger arm and a bezel arm, the plunger arm and the bezel arm being biased to diverge;
wherein the gasket is positioned between the bezel rim and the sealing perimeter so that, while the stem moves between the extended position and the retracted position, the bezel arm continuously contacts the bezel rim and the plunger arm continuously contacts the sealing perimeter.

25. The gaming machine of claim 23, wherein the at least one push-button assembly actuates an optical switch by blocking a light beam between a photoemitter and a photodetector.
